(19) United States
(12) Patent Application Publication
(10) Pub. No.: US 2009/0262732 A1
(43) Pub. Date: Oct. 22, 2009

(54) Data Communications Network

(76) Inventor: Barry Wood, Dunrobin (CA)

Correspondence Address: Anderson Gorecki & Manaras LLP, 33 NAGOG PARK, ACTON, MA, 01720, US

(21) Appl. No.: 12/103,996

(22) Filed: Apr. 16, 2008

(51) Int. Cl. H04L 12/56

(52) U.S. Cl. 370/389

(57) ABSTRACT

In a system comprising a first subsystem having a first plurality of nodes connected through an interconnect providing unreliably delivery (URD) of packets and a second subsystem having a second plurality of nodes connected through a packet-based interconnect offering reliable delivery of packets, a method of communicating comprising the step of transporting in both the first and second subsystem, a common packet format. The URD and packet interconnects conform with a standard. The standard is Serial RapidIO. The first subsystem places a Serial RapidIO idle sequence after each packet. The first subsystem places the Serial RapidIO idle sequence after a Multicast Event Control Symbol (MECS).

### CROSS-REFERENCE TO RELATED APPLICATIONS

A claim of priority is made to U.S. Provisional Patent Application 60/912739, entitled DATA COMMUNICATIONS NETWORK, filed Apr. 19, 2007, which is incorporated by reference.

### FIELD OF THE INVENTION

The present invention relates to data communications networks and is particularly concerned with hybrid packet and time-division multiplexing (TDM) networks.

### BACKGROUND OF THE INVENTION

In wireless communication systems, it is necessary to transfer data samples from the remote radio head (RRH) to signal processing equipment, and to transfer data samples for transmission from signal processing equipment to the RRH. This problem has generally been solved using proprietary technology in the past. Lately, new standards such as Common Public Radio Interface (CPRI) and Open Base Station Architecture Initiative (OBSAI) have attempted to address this problem using a time-division multiplexing (TDM) approach..

Referring to FIG. 1, there is illustrated a known hybrid network. The known hybrid network 10 includes a packet network 12, a time-division multiplex (TDM) network 14 and a bridge 16 between the two network domains. The TDM network 14 typically includes a plurality of remotes 18. The packet network 12 includes delivery guarantee for packets within its domain.

In operation, a packet, within the packet network 12, carrying information for one of the remotes 18 must be converted for transmission in the other network 14 (in the present example a TDM network). Format conversion takes place in the bridge 16 and may include a variety of treatments.

Processing delays in the bridge may make it difficult to determine network delays needed for certain protocols. An approach is needed that does not introduce additional delays.

### SUMMARY OF THE INVENTION

An object of the present invention is to provide an improved data communications network.

In accordance with an aspect of the present invention there is provided a system comprising a first subsystem having a first plurality of nodes connected through an interconnect providing unreliably delivery (URD) of packet and a second subsystem having a second plurality of nodes connected through a packet-based interconnect offering reliable delivery of packets, both the first and second subsystem use a common packet format.

In accordance with another aspect of the present invention there is provided in a system comprising a first subsystem having a first plurality of nodes connected through an interconnect providing unreliably delivery (URD) of packets and a second subsystem having a second plurality of nodes connected through a packet-based interconnect offering reliable delivery of packets, a method of communicating compressing the step of transporting in both the first and second subsystem, a common packet format.

### BRIEF DESCRIPTION OF THE DRAWINGS

The present invention will be further understood from the following detailed description with reference to the drawings in which:

FIG. 1 illustrates a known hybrid network;

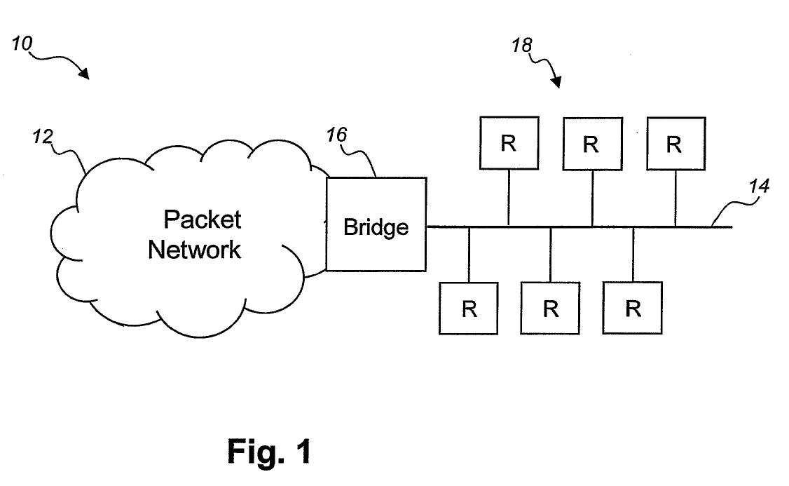

FIG. 2 illustrates a hybrid network in accordance with an embodiment of the present invention;

FIG. 3 illustrates a hybrid network in accordance with a further embodiment of the present invention;

FIG. 4 illustrates a remote radio head for the hybrid network of FIG. 3 in greater detail;

FIG. 5 illustrates the effect of single bit errors according to the RapidIO protocol; and

FIG. 6 illustrates the effect of single bit errors on IDLE sequence, MECS and packet delineation

### DETAILED DESCRIPTION OF THE PREFERRED EMBODIMENT

The present specification describes by way of example how to make use of a modified RapidIO protocol, which is packet based, to effect the transfer of data samples between signal processing equipment and RRH over long distances.

The present specification describes by way of example the use of a packet based protocol to transfer antenna data between signal processing equipment and the RRH over long distances.

The present specification describes by way of example the use of the RapidIO Multicast Event Control Symbol (MECS) to calibrate link length, and to indicate time information to the RRH.

The present specification describes by way of example the modification of the RapidIO protocol to allow a MECS to be looped back on the same link on which it was received.

The present specification describes by way of example the modification of the RapidIO link transmission protocol to avoid throughput limitations of the RapidIO ackID size.

The present specification describes by way of example the use modification of the RapidIO link transmission protocol to avoid loss of antenna data or MECS in the event of single bit errors.

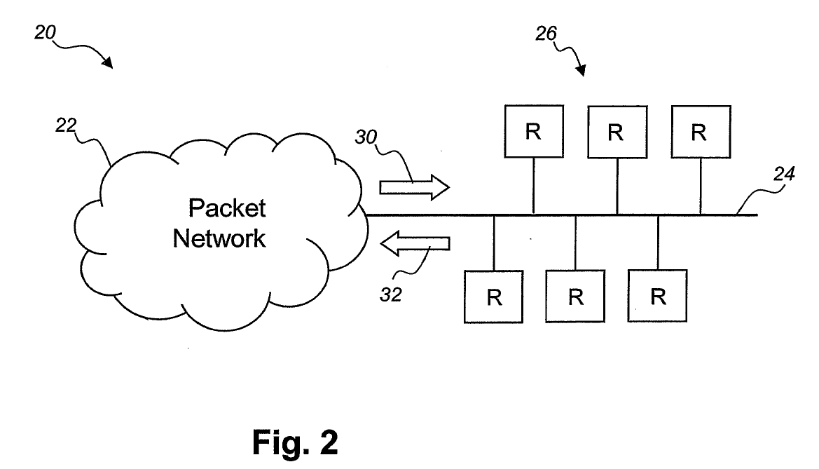

Referring to FIG. 2, there is illustrated a hybrid network in accordance with an embodiment of the present invention. The hybrid network 20 includes a first packet network 22, a second packet network 24. The first packet network 22 guarantees delivery of every packet, while the second packet network does not and there is no bridge between the two network domains. The second packet network 24 typically includes a plurality of remotes 26.

In operation, a packet 30 from within the packet network 12, carrying information for one of the remotes 18 is transmitted to the second packet network 14 without format conversion. The remote 26, receiving the packet transmits a packet 32 back to the first packet network 12. In this way network delay from the source to the remote and back can be determined. There are numerous applications for this feature.

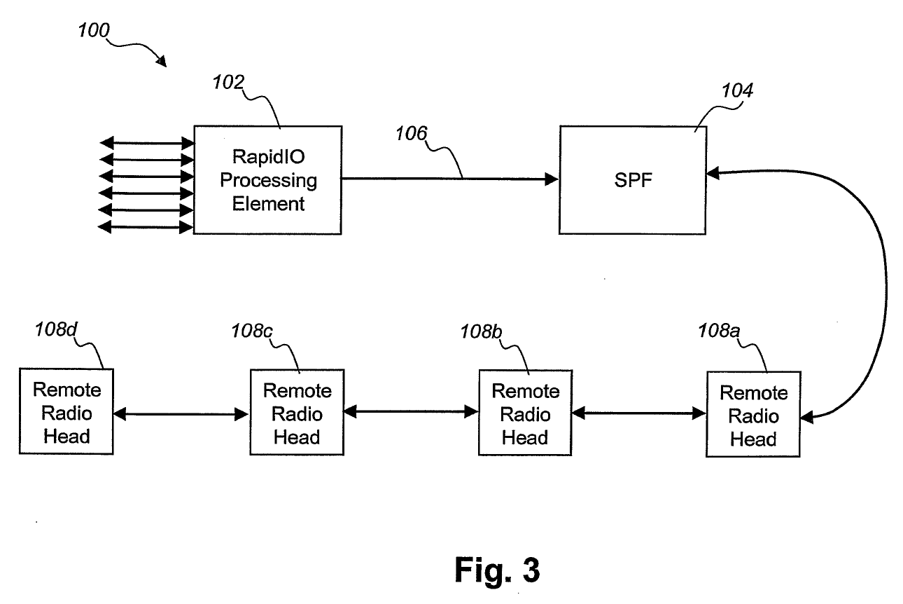

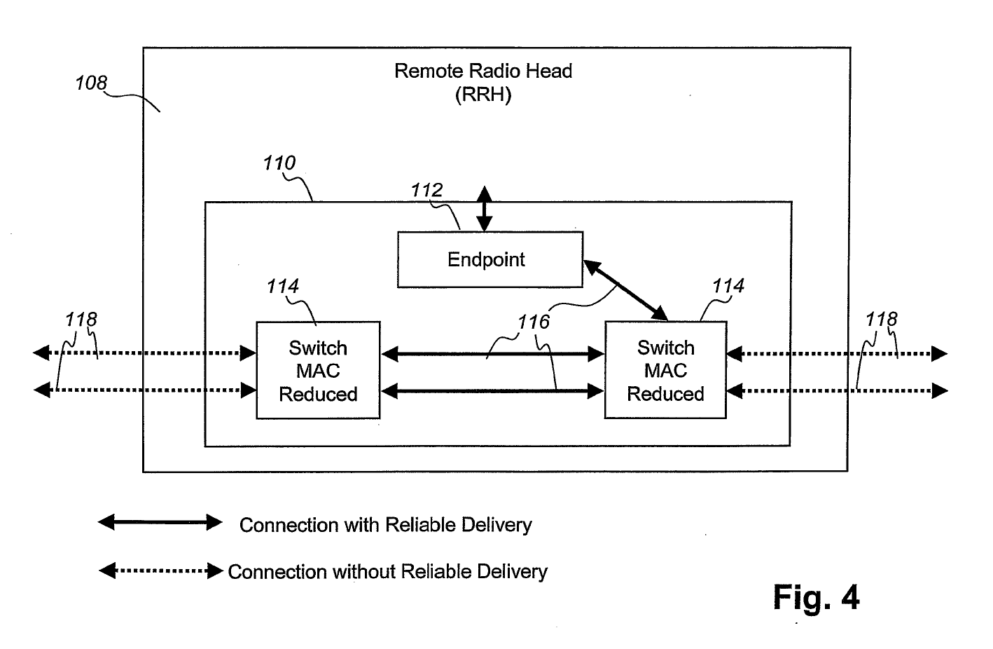

Referring to FIG. 3, there is illustrated a hybrid network in accordance with a further embodiment of the present invention;. The hybrid network 100 includes a RapidIO processing element 102 coupled to a SPF 104, via a link 106 and a plurality of remote radio heads (RRH) 108a-108d. In operation, the output buffers 106 allow a high priority packet to be output directly while buffering a low priority packet. Further explanation is provided in conjunction with FIG. 4.

Referring to FIG. 4 there is illustrated the remote radio head for the hybrid network of FIG. 3 in greater detail. Each RRH 108 implements a combiner function, as shown in FIG. 4.

In operation, in the upstream direction (traffic going towards the Packet Network), traffic is received from downstream RRH (118 on the left) and from the endpoint (112) and must be combined in a fair manner by the “Switch MAC Reduced” (114 on the right). It is necessary to allow the endpoint only its fair share of the upstream bandwidth in order to ensure that traffic from downstream ports are not dropped.

The use of a packet based interface for data sample transmission overcomes the following issues.

First, the RRH 108 requires extremely accurate knowledge of absolute time. Hence, the delay between sending data from the signal processing equipment 102 and its reception by the RRH 108 needs to be calibrated. The RRH 108 also requires regular, accurate transmission of a signal that indicates the progress of time.

The standard RapidIO protocol defines the Multicast Event Control Symbol (MECS), which can be sent with minimal variability according. To calibrate the delay, however, requires a modification of the RapidIO implementation to allow an MECS to be sent back with minimal delay and variation on the same link on which it was received. There are a many different possible implementations of this MECS loopback.

Regular, accurate transmission of MECS during normal system operation from the RapidIO processing element 102 to the RRHs 108a-d can deliver regular, accurate indications of the progress of time. A notification delay function within each RRH, calibrated according to the differences in loop length between the RRHs, can be used to remove the skew between reception of MECS at the first RRH 10 8a and the last RRH 108d.

Second, configuration, status and error information is required to be sent to and from the RRH 108 while the antenna data is being transferred.

RapidIO has multiple packet formats to accommodate these needs. Collectively, these are denoted as ‘OAM packets’ in the rest of the present disclosure.

Third, the clock signal used by the RRH 108 needs to be linked to the clock signal that drives the baseband equipment.

Standard RapidIO makes use of a variation of the XAUI transmission standard, which encodes a clocking signal within the data transmitted. This clock signal is recovered by the receiver. The recovered clock signal is subjected to jitter attenuation before being sent to the RRH 108. There are many different possible implementations of jitter attenuation circuitry.

Fourth, antenna data needs to be delivered at gigabit rates at the end of a cable several kilometres long. However, the RapidIO physical layer protocol restricts the number of packets that can be in flight to 31 (RapidIO 1.3 spec) or to 63 (RapidIO 2.0 spec). This is insufficient to allow the RapidIO physical layer packet transfer protocol to transfer data reliably at the end of a long link with sufficient throughput. Additionally, the latency for retransmitting a corrupted packet (microseconds) cannot be absorbed in the time critical flow of transmission data.

To solve this issue, the aspects of the RapidIO protocol that enable reliable packet transfer at the physical layer are removed. Specifically:
Packet CRC checking does not result in an antenna data packet being dropped and a retransmission request being sent.
The RapidIO Physical layer packet field, which indicates packet sequence on the link (ackID), is ignored for purposes of packet transfer.
Packet Accept, Packet Not Accepted, Packet Retry, Status, Link-Request/Input-Status, Link-Request/Link Response, Restart from Retry, and STOMP control symbols and their associated functionality in the protocol, are never transmitted and ignored when received.
If a packet is being received when there are insufficient resources to receive the packet, that packet is dropped (it cannot be retried!)

Fifth, packets that contain antenna data can not be dropped due to single bit errors, as this would unduly impact the quality of the air interface.

To solve this issue, the routing information in the RapidIO packet is encoded in a way that allows detection and correction of single bit errors in the values that determine the destination of the antenna data.

The Antenna Identifier (Antenna ID) and the Buffer Identifier (Buffer ID) are the two values that determine the destination of antenna data. The Antenna ID is encoded as a byte, which is repeated four times in the packet, in the Destination ID and Source ID fields. The Buffer ID is also encoded as a single byte, which is repeated at least four times in the Address field of the packet. The antenna data is transferred using SWRITE packets, as the SWRITE packet has the least amount of information in its logical layer header. Other packet types (NWRITE, NWRITE_R) can use the same approach and the same fields.

A Data Streaming (type 9) packet may also be used, where the Buffer ID is encoded as four bytes which include the COS, Stream ID, S, E, O, P, X, and reserved bit in the logical layer header.

The 8B/10B encoding scheme used to transmit Serial RapidIO has the property that a single bit error will corrupt at most two symbols. Therefore, detection of corruption the correct value is always the first valid value is a matter of selecting the value that occurs twice most often in the selected field.

These packet formats and encodings allow standard RapidIO packets to be routed to the correct destination in the presence of single bit errors, when transmitted on a single lane. This scheme does not completely protect against single bit errors when the packet is striped across on multiple lanes as is required for multiple lane RapidIO connects. However, for this scheme to fail single bit errors must occur nearly simultaneously on at least two lanes within one of the two encoded values. Assuming a bit error rate of 10-15, this will occur approximately once in 16 billion years at 3.125 Gbaud.

Control symbols can also be corrupted due to single bit errors. In standard RapidIO protocol, this can result in loss of delineation of packets. The RapidIO transmission protocol is therefore modified as follows:
A packet must be followed by at least four bytes of the idle sequence.
A MECS must be followed by at least four bytes of the idle sequence.
Transmission and forwarding of an MECS is delayed by an amount of time that allows completion of the transmission of a packet and the associated idle sequence to avoid jitter in MECS transmission.

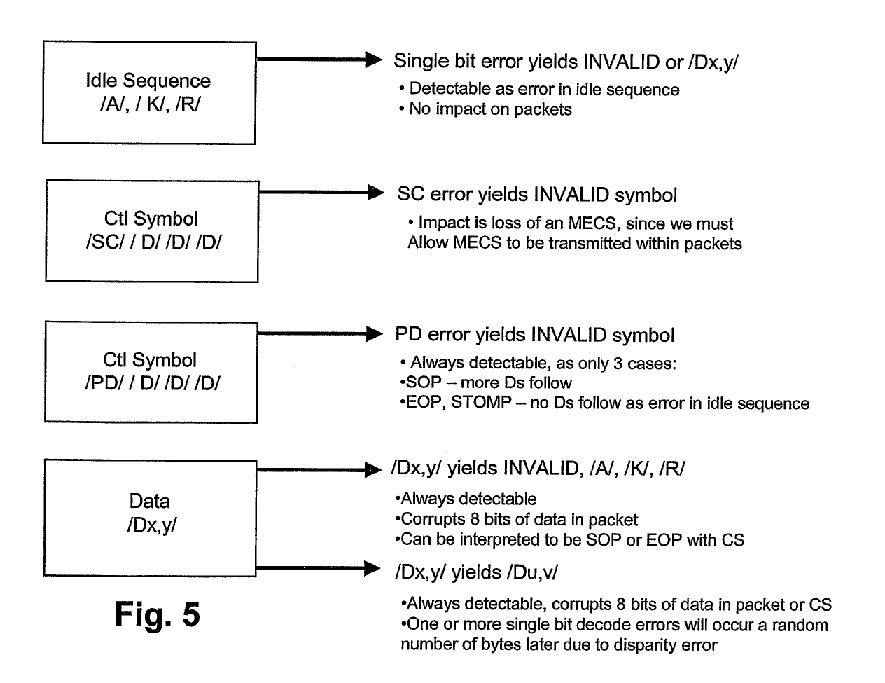

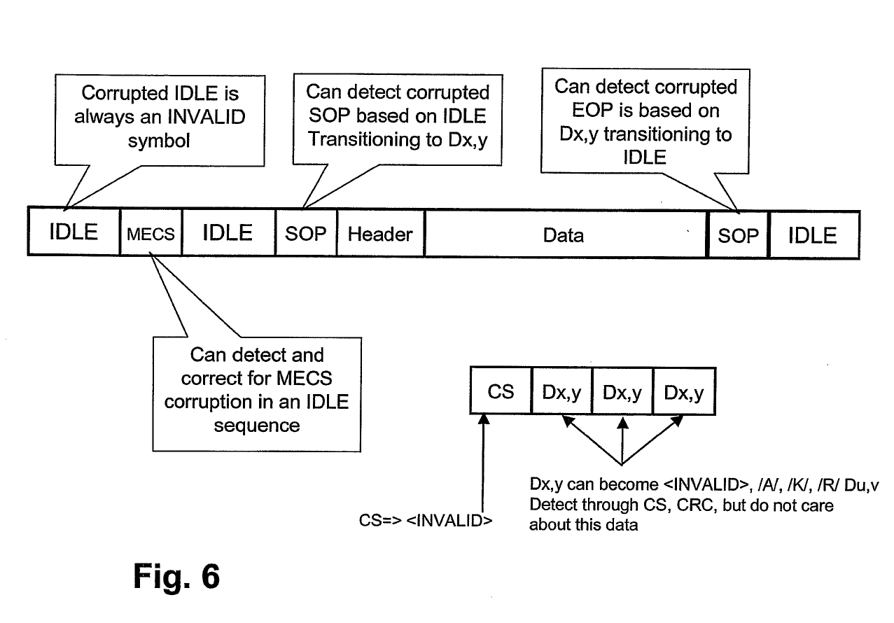

The effect of single bit errors when using these rules is diagrammed in FIGS. 5 and 6.

An MECS is always delivered correctly. A packet is always completely received, never partially received.

Within the base-band processing equipment, a standard 16-bit destination ID is used to select the antenna that should receive the packet. When the packet is transmitted on the antenna link, the 16-bit destination ID is translated to an 8 bit antenna ID. The Antenna ID is then put into both the DestID and SourceID fields of the packet. The address of the write is translated to a Buffer ID value. There are a number of different ways to do this. One method is to use a base address, and a size, to compute the Buffer ID value based on the packet address. This allows the sequence of antenna data samples to be specified using the Buffer ID value.

Each antenna transmits data with its antenna ID, and a Buffer ID value. The Buffer ID value starts at 0, and rolls over to 0 at a configurable number. Before the antenna data packet is transferred to the signal processing equipment, the Antenna ID is translated to a Source ID based on the Antenna ID. The destination of the packet within the signal processing equipment is also selected based on the Antenna ID. The address of the packet is computed based on the Antenna ID and the Buffer ID value, and placed into the Address field of the SWRITE. This allows each antenna to send a stream of antenna samples to a DSP that contains two or more buffers. Of course, the mapping function from Antenna ID and Buffer ID to address is implementation specific. If a Type 9 packet is used, the logical layer fields can be constant for single segment packets.

Note that OAM packets, because of their implementation specific nature, are not subject to the complete mapping function, since the Source ID field must be preserved in the downlink direction. Before an OAM packet is transmitted to an antenna, the 16 bit destination ID used to address the antenna is translated to an antenna ID. The Antenna ID value is placed in the DestID field of the packet, but not in the Source ID. If an OAM packet requires a response, the Antenna composes the response by reversing the Source ID and DestID fields to ensure that the source of the request receives the response.

If an OAM packet is composed by the Antenna, it uses a signal processing equipment 16 bit destination ID for the destID field value, and its own Antenna ID repeated twice as the Source ID.

Before an OAM packet is sent to the signal processing equipment, the Source ID field (Antenna ID) is translated to the destination ID used by the signal processing equipment to address the Antenna.

This scheme allows the routing information of OAM packets to be corrupted in an uncorrectable manner. Corruption can be detected through checking the packets CRC value. Corrupted OAM packets may be discarded, or treated in any other manner by the system.

The best method for differentiating Antenna Data packets from OAM packets is based on the size of the packet, since that portion of the physical layer header which identifies the packet is subject to corruption. If Antenna Data packets have a unique size in the system, and because we always receive a complete packet (no more, no less), it is possible to identify an Antenna Data packet based on its size.

Six, each RRH on the antenna link routes the packets correctly in the downlink direction, and combines the packets it sends with the packets from other RRH's on the downlink send without starving the other RRHs of bandwidth.

One solution for routing packets in the downlink direction is to base the routing on the first value to occur twice in the DestID and SourceID fields of any packet. Other routing strategies are also possible, based on differentiating OAM packets from Antenna Data packets. Error handling when an OAM packet has had its routing information corrupted has many different possibilities, one being to drop the OAM packet.

In the uplink direction, the antenna consumes only the amount of bandwidth that it is allowed in the uplink direction. The bandwidth allocated each antenna allows all downstream antennas to send all of their data in the uplink direction, along with a certain amount of OAM packets.

Seven, the switch fabric in the signal processing equipment correctly combines the antenna data from multiple sources and send it.

This can be a hard problem to solve in a strictly priority based RapidIO system:
Antenna data is sent at the highest priority
The links feeding antenna data are faster than the antenna data link
A scheduling WRR algorithm is used to allow antenna data to be sent in a dependable order. One algorithm to use is a two-tiered Weighted Round Robin algorithm, which ensures that antenna data is sent and also allows some share for OAM packets as well.
The WRR algorithm allows some dependable bandwidth for OAM packets as well.
The RapidIO deadlock/reordering rules need not be followed for the packets routed to the downlink. It is allowable to have lower priority OAM packets from one port, for example, to be sent ahead of antenna data packets from another port.

In a system which has virtual channels, bandwidth and fair share algorithms are more straightforward to implement. However, the need for WRR and faster feeders is still there.

Numerous modifications, variations and adaptations may be made to the particular embodiments described above without departing from the scope patent disclosure, which is defined in the claims.

What is claimed is:

1. A system comprising:
a first subsystem having a first plurality of nodes connected through an interconnect providing unreliably delivery (URD) of packets; and
a second subsystem having a second plurality of nodes connected through a packet-based interconnect offering reliable delivery of packets;
both the first and second subsystem use a common packet format.

2. A system as in claimed in claim 1, wherein the URD and packet interconnects conform with a standard.

3. A system as in claimed in claim 2, wherein the standard is Serial RapidIO.

4. A system as in claimed in claim 3 wherein the first subsystem places a Serial RapidIO idle sequence after each packet.

5. A system as in claimed in claim 3 wherein the first subsystem places the Serial RapidIO idle sequence after a Multicast Event Control Symbol (MECS).

6. A system as in claimed in claim 5 wherein the first subsystem includes elements for delaying a MECS transmission by a predetermined time, during which Serial RapidIO packet transmission can be completed, before transmitting the MECS to any downstream node.

7. A system as in claimed in claim 5 wherein including a translation between values in the second subsystem and values in the first subsystem such that the values in the second subsystem are encoded in the first subsystem as a 8B/10B character repeated at least four times.

8. A system as in claimed in claim 7 wherein packet routing and address information are encoded in the first subsystem as the same 8B/10B character repeated at least four times.

9. A system as in claimed in claim 8 wherein packet routing in the first subsystem is based on the first two repeated 8B/10B characters for values encoded as the same 8B/10B character repeated at least four times.

10. In a system comprising a first subsystem having a first plurality of nodes connected through an interconnect providing unreliably delivery (URD) of packets and a second subsystem having a second plurality of nodes connected through a packet-based interconnect offering reliable delivery of packets, a method of communicating compressing the step of:
transporting in both the first and second subsystem, a common packet format.

11. A method as in claimed in claim 10, wherein the URD and packet interconnects conform with a standard.

12. A method as in claimed in claim 11, wherein the standard is Serial RapidIO.

13. A method as in claimed in claim 12 wherein the first subsystem places a Serial RapidIO idle sequence after each packet.

14. A method as in claimed in claim 13 wherein the first subsystem places the Serial RapidIO idle sequence after a Multicast Event Control Symbol (MECS).

15. A method as in claimed in claim 14 wherein the first subsystem includes elements for delaying a MECS transmission by a predetermined time, during which Serial RapidIO packet transmission can be completed, before transmitting the MECS to any downstream node.

16. A method as in claimed in claim 15 wherein including a translation between values in the second subsystem and values in the first subsystem such that the values in the second subsystem are encoded in the first subsystem as a 8B/10B character repeated at least four times.

17. A method as in claimed in claim 16 wherein packet routing and address information are encoded in the first subsystem as the same 8B/10B character repeated at least four times.

18. A method as in claimed in claim 17 wherein packet routing in the first subsystem is based on the first two repeated 8B/10B characters for values encoded as the same 8B/10B character repeated at least four times.
